(19) United States
(12) Patent Application Publication
(10) Pub. No.: US 2024/0184713 A1
(43) Pub. Date: Jun. 6, 2024

(54) METHOD AND APPARATUS FOR MANAGING VIRTUAL MEMORY IN HETEROGENEOUS SYSTEM, AND STORAGE MEDIUM STORING INSTRUCTIONS TO PERFORM METHOD FOR MANAGING VIRTUAL MEMORY

(71) Applicant: RESEARCH & BUSINESS FOUNDATION SUNGKYUNKWAN UNIVERSITY, Suwon-si (KR)

(72) Inventors: Jungrae KIM, Suwon-si (KR); Jihun PARK, Suwon-si (KR); Donghun JEONG, Suwon-si (KR)

(73) Assignee: RESEARCH & BUSINESS FOUNDATION SUNGKYUNKWAN UNIVERSITY, Suwon-si (KR)

(21) Appl. No.: 18/529,534

(22) Filed: Dec. 5, 2023

(30) Foreign Application Priority Data
Dec. 5, 2022 (KR) 10-2022-0168002

(51) Int. Cl. G06F 12/1018

(52) U.S. Cl. CPC G06F 12/1018

(57) ABSTRACT

There is provided a method for managing a virtual memory in a heterogeneous system. The method comprises receiving a request for accessing to a page in the heterogeneous system; determining a physical address corresponding to an address of the page in the device memory; generating a frame indentification of a migration destination of the device memory using an inverted page table stored in the device memory, when the determined physical address indicates an address allocated to the system memory; and performing page migration to the system memory using the frame indentification and the physical address.

### TECHNICAL FIELD

The present disclosure relates to a computing field of a microprocessor, and particularly relates to memory virtualization and data migration.

This work was supported by Institute of Information & communications Technology Planning & Evaluation (IITP) grant funded by the Korea government (MSIT; Ministry of Science and ICT; R&D) (No.: 2019-0-00421-003, and Artificial intelligence graduate school application), and National Research Foundation of Korea (NRF) grant funded by the Korea government (MSIT) (No.: 2020R1C1C1011419, Research on network improvement of distributed artificial intelligence systems, and No.: 2020M3H2A1076786, Industry-academic IoT semiconductor system convergence human resources training center).

### BACKGROUND

In a computing system environment, a unified memory technology has been introduced to automate data migration between mutually different heterogeneous sets, such as a CPU memory and a GPU memory, and to support memory overuse. The unified memory technology facilitates software programming. However, software-based migration may result in excessive overhead. Therefore, it is actually desirable to provide a technology for minimizing overhead of a unified memory during data migration.

### SUMMARY

An embodiment of the present disclosure proposes a virtual memory management technology for a heterogeneous system which detects access to a local memory and migrates pages without software intervention.

An embodiment of the present disclosure proposes a virtual memory management technology for a heterogeneous system which may improve performance in a manner such that a time required for page migration is reduced by offloading a page fault and software processing to hardware.

The aspects of the present disclosure are not limited to the foregoing, and other aspects not mentioned herein will be clearly understood by those skilled in the art from the following description.

In accordance with an aspect of the present disclosure, there is provided a method for managing a virtual memory in a heterogeneous system that performs data migration between a system memory and a device memory, the method comprises: receiving a request for accessing to a page in the heterogeneous system; determining a physical address corresponding to an address of the page in the device memory; generating a frame indentification of a migration destination of the device memory using an inverted page table stored in the device memory, when the determined physical address indicates an address allocated to the system memory; and performing page migration to the system memory using the frame indentification and the physical address.

The generating of the frame indentification may include selecting the frame indentification required for migration from the inverted page table when an available space of a destination candidate queue is equal to or higher than a preset ratio; and storing the frame indentification in the destination candidate queue.

The storing of the frame indentification in the destination candidate queue may include: determining whether a free frame exists in a frame region, selecting a first frame indentification corresponding to a frame indentification of the free frame by accessing the inverted page table when the free frame exists in the frame region, and filling the destination candidate queue with the first frame indentification.

The determining of whether the free frame exists may include retrieving a frame region in units of 2 MB (mega-byte) in which the free frame exists from an available bitmap in the frame region.

The filling of the destination candidate queue with the first frame indentification may include allocating a flag of the destination candidate queue to 0.

The storing of the frame indentification in the destination candidate queue may include selecting a second frame indentification corresponding to a random pseudo-frame number by accessing the inverted page table when the free frame does not exist, and filling the destination candidate queue with the second frame indentification.

The selecting of the second frame indentification may include receiving the random pseudo-frame number from a pseudo-random number generator when the free frame does not exist.

The filling of the destination candidate queue with the second frame indentification may include allocating a flag of the destination candidate queue to 1.

The determining of the physical address in the device memory may include determining a page table entry corresponding to the address of the page from a page table of the device memory, and determining the physical address of the page using the determined page table entry.

The method further comprises updating the page table entry after the page migration is performed; and returning the updated page table entry to an entity transmitting the request for accessing to the page.

The inverted page table may map and store a frame and the page of the device memory.

The page migration is performed in units of a page or in units of a page group, and the heterogeneous system performs memory management in units of the page or the page group or in units of a frame or a frame group.

In accordance with another aspect of the present disclosure, there is provided an apparatus for managing a virtual memory management device in a heterogeneous system, the apparatus comprises: a system memory; a device memory configured to store an inverted page table; a processor memory configured to store one or more instructions; and a processor configured to execute the one or more instructions stored in the processor memory, wherein the instructions, when executed by the processor, cause the processor to: receive a request for accessing to a page in the heterogeneous system, determine a physical address corresponding to an address of the page in the device memory, generate a frame indentification of a migration destination of the device memory using the inverted page table stored in the device memory, when the determined physical address indicates an address allocated to the system memory, and perform page migration to the system memory using the frame indentification and the physical address.

The processor may select a frame indentification required for migration from the inverted page table and store the frame indentification, and generates and provides a random pseudo-frame number when a free frame does not exist in a frame region.

The processor may select a frame indentification required for the migration from the inverted page table when an available space of the destination candidate queue is equal to or higher than a preset ratio, and store the frame indentification in the destination candidate queue.

The processor may select a first frame indentification corresponding to a frame indentification of the free frame, and fill the destination candidate queue with the first frame indentification when the free frame exists in the frame region, the processor.

The processor may determine a frame region in units of 2 MB in which the free frame exists from an available bitmap in the frame region.

The processor may allocate a flag of the destination candidate queue to 0.

When the free frame does not exist in the frame region, the processor may select a second frame indentification corresponding to a random pseudo-frame number by accessing the inverted page table, and fill the destination candidate queue with the second frame indentification.

The processor may allocate a flag of the destination candidate queue to 1.

In accordance with another aspect of the present disclosure, there is provided a non-transitory computer-readable recording medium storing a computer program, which comprises instructions for a processor to perform a method for managing a virtual memory in a heterogeneous system that performs data migration between a system memory and a device memory, the method comprises: receiving a request for accessing to a page in the heterogeneous system; determining a physical address corresponding to an address of the page in the device memory; generating a frame indentification of a migration destination of the device memory using an inverted page table stored in the device memory, when the determined physical address indicates an address allocated to the system memory; and performing page migration to the system memory using the frame indentification and the physical address.

According to an embodiment of the present disclosure, access to a local memory may be detected, a page may be migrated without software intervention, and a page fault and software processing are offloaded to hardware. In this manner, a time required for page migration may be reduced, and performance may be improved. A total execution time does not rapidly increase even when the memory is overused. Therefore, the present disclosure may be effectively used in various fields such as artificial intelligence learning by using more data in the memory having a limited volume.

### BRIEF DESCRIPTION OF THE DRAWINGS

FIG. 1 is a block diagram of a virtual memory management device for a GPU according to an embodiment of the present disclosure.

FIG. 2 is a detailed block diagram of a destination allocation unit 110 in the virtual memory management device for the GPU according to the embodiment of the present disclosure.

FIG. 3 is a flowchart illustrating a virtual memory management method for the GPU according to the embodiment of the present disclosure.

FIG. 4 is a detailed flowchart of a step S200 of generating a frame number in FIG. 3, and is a flowchart illustrating a processing step example of the destination allocation unit 110 of the virtual memory management device for the GPU according to the embodiment of the present disclosure.

FIGS. 5 to 7 are comparative graphs obtained by simulating a virtual memory management method in the related art and a virtual memory management method according to the embodiment of the present disclosure.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

An embodiment of the present disclosure proposes a virtual memory management technology which may detect accesses to a local memory, may migrate a page without software intervention, can reduce a time required for page migration, and may improve performance in a manner such that a page fault and software are offloaded to hardware and all steps in the page migration are quickly processed by using only the hardware without causing the page fault.

Specifically, according to the embodiment of the present disclosure, when a page is allocated to a system memory through a page table entry (PTE) of a page table of a GPU memory to process all steps by using the hardware, a physical frame number (PFN) of the system memory may be stored.

In addition, since an inverted page-group table is additionally provided, a destination frame address of the GPU memory may be identified in advance during the page migration.

In addition, a basic migration unit is 64 KB, and 16 pages of 4 KB may be migrated at once. According to this configuration, the embodiment of the present disclosure may achieve a prefetching effect. In the present disclosure, this unit will be referred to as a page group. Similarly, 16 memory frames of 4 KB will be referred to as a frame-group.

In addition, in the embodiment of the present disclosure, for example, a heterogeneous system may include the CPU and the GPU in a computing environment, and a system memory and a device memory for virtual memory management may include the CPU memory and the GPU memory. The CPU, the GPU, the CPU memory, and the GPU memory which are specified below are only examples to facilitate understanding of the present disclosure, and it should be noted that other configurations may be included in the heterogeneous system. This will become clear from the appended claims described below.

In addition, in describing the embodiment below, the page group, the frame-groups, a group table, and a group number are only examples to facilitate understanding of the present disclosure, and do not necessarily limit a case of performing memory management in a group unit. However, it should be noted that the pages and the memory frames may be managed in a large group unit to enable faster memory management. This will become clear from the appended claims described below.

Hereinafter, an embodiment of the present disclosure will be described in detail with reference to the attached drawings.

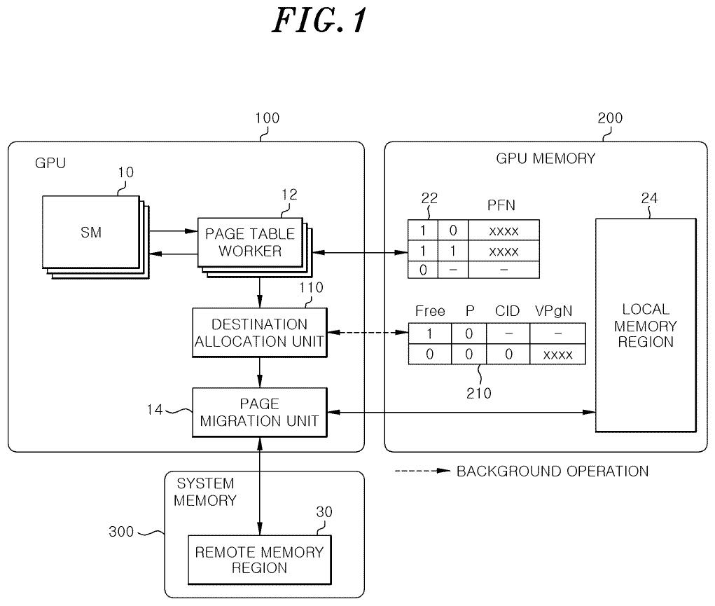

FIG. 1 is a block diagram of a virtual memory management device of a GPU 100 according to the embodiment of the present disclosure. The virtual memory management device of the GPU 100 according to the embodiment of the present disclosure may perform data migration between a system memory 300 and a GPU memory 200.

As illustrated in FIG. 1, the virtual memory management device of the GPU 100 may include a streaming multiprocessor (SM) 10, a page table worker 12, a destination allocation unit 110, and a page migration unit 14.

In the virtual memory management device of the GPU 100, the GPU memory 200 and the system memory 300 may be connected.

The GPU memory 200 may include a page table 22, an inverted page group table 210, and a local memory region 24, and the system memory 300 may include a remote memory region 30.

The page table 22 in the GPU memory 200 includes a PFN as a physical address of the system memory, and an A-flag indicating a current location of the page. One column of the PFN and the A-flag may be referred to as a page table entry.

The inverted page group table 210 in the GPU memory 200 maps and stores the frame-group and the page group of the GPU memory 200 in an inverted page table format.

A free flag, a P-flag, a context ID CID, and a virtual page group number VPgN are stored in each table entry of the inverted page group table 210. The free flag indicates whether there is a page group allocated to the frame-group. The P-flag indicates whether the frame-group is “protected” and cannot be used for migration. The CID refers to a context ID of the GPU, and is used to distinguish various virtual address spaces. The virtual page group number VPgN refers to a page group number allocated to the frame-group.

The streaming multiprocessor 10 in the GPU 100 may access a page, based on a page access request to the GPU 100.

When the streaming multiprocessor 10 accesses the page, the page table worker 12 may retrieve a physical address corresponding to an address of the page from the GPU memory 200. Specifically, the page table worker 12 may retrieve the page table entry corresponding to the address of the page accessed by the streaming multiprocessor 10 from the page table 22 of the GPU memory 200, and may retrieve the physical address of the page accessed by the streaming multiprocessor 10, based on the retrieved page table entry.

When the physical address retrieved through the page table worker 12 is the address allocated to the system memory 300, the destination allocation unit 110 may generate the frame-group number of the migration destination of the GPU memory 200, based on the inverted page group table 210 of the GPU memory 200.

The page migration unit 14 may perform the page migration to the system memory 300, based on the frame-group number and the physical address. In this case, the page migration may be performed in a page group unit.

Meanwhile, when the page migration is completely performed, the GPU 100 may update the page table entry, and may return the updated page table entry to the streaming multiprocessor 10.

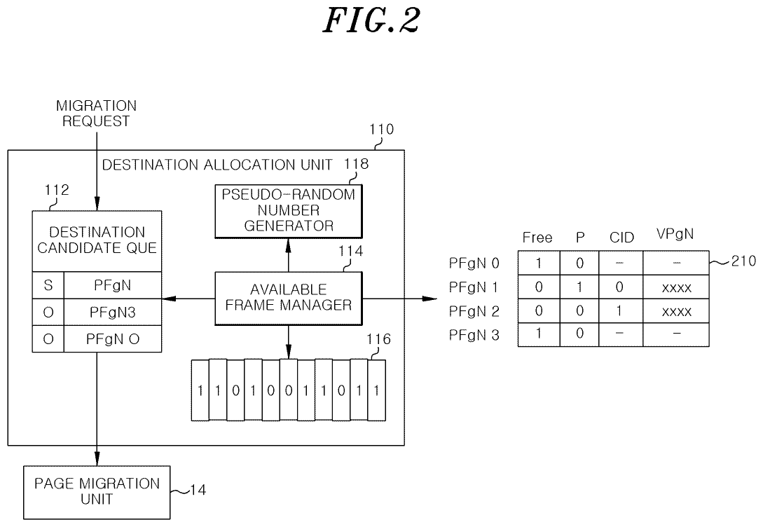

FIG. 2 is a detailed block diagram of the destination allocation unit 110 in the virtual memory management device of the GPU 100 according to the embodiment of the present disclosure.

The destination allocation unit 110 according to the embodiment of the present disclosure may include a destination candidate queue 112, an available frame manager 114, a frame region available bitmap 116, and a pseudo-random number generator 118.

The destination candidate queue 112 may store the frame-group number selected through the available frame manager 114 which will be described later.

Specifically, the destination candidate queue 112 is an internal component of the destination allocation unit 110, and is a queue that stores the frame-group number selected by the available frame manager 114. The destination candidate queue 112 includes 64 entries in total, and each entry has the frame-group number and a swap flag S. The swap flag indicates whether swapping with a new page group is required since another page group is already allocated to the frame-group.

The available frame manager 114 may select the frame-group number required for the migration from the inverted page group table 210, and may store select the frame-group number in the destination candidate queue 112.

When an available space for the destination candidate queue 112 is equal to or higher than a preset ratio, for example, 50%, the available frame manager 114 may select the frame-group number required for the migration from the inverted page group table 210, and may store the frame-group number in the destination candidate queue 112.

When a free frame-group exists in a frame region, the available frame manager 114 may access the inverted page group table 210, may select a first frame-group number corresponding to the frame-group number of the free frame-group, may fill the destination candidate queue with the first frame-group number, and may allocate a flag of the destination candidate queue 112 to 0.

The available frame manager 114 may retrieve a frame region in a certain size unit, for example, 2 MB, in which the free frame-group exists, from the available bitmap 116 in the frame region. That is, the frame region available bitmap 116 has an SRAM bitmap structure, and indicates whether at least one free frame-group exists in each frame region in units of 2 MB.

In addition, when the free frame-group does not exist in the frame region, the available frame manager 114 may access the inverted page group table, may select a second frame-group number corresponding to a random pseudo-frame-group number, may fill the destination candidate queue 112 with the second frame-group number, and may allocate the flag of the destination candidate queue to 1.

When the free frame-group does not exist, the available frame manager 114 may receive the random pseudo-frame-group number from the pseudo-random number generator 118.

When the free frame-group does not exist in the frame region, the pseudo-random number generator 118 may generate the random pseudo-frame-group number, and may provide the random pseudo-frame-group number for the available frame manager 114.

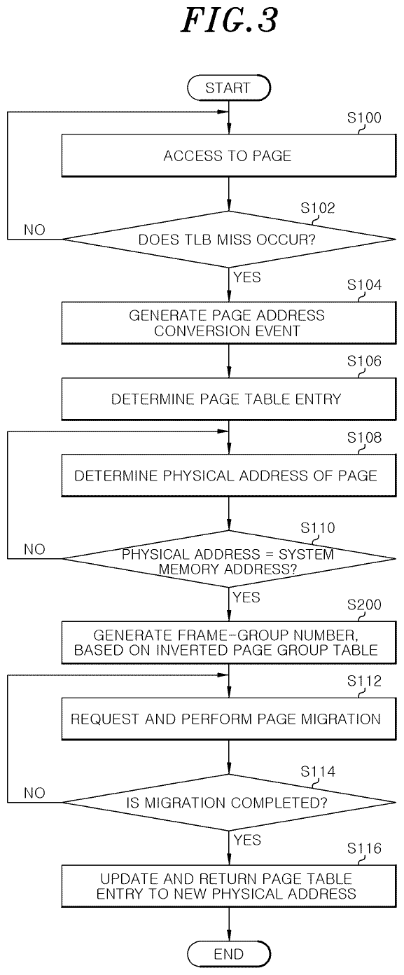

FIG. 3 is a flowchart illustrating a virtual memory management method for the GPU 100 according to the embodiment of the present disclosure.

As illustrated in FIG. 3, in a case where a translation lookaside buffer TLB miss occurs when the streaming multiprocessor 10 of the GPU 100 accesses the page (S100 and S102), the streaming multiprocessor 10 may generate a page address conversion event for the page table worker 12 (S104).

In the page address conversion event, the page table worker 12 may retrieve the page table entry through the GPU memory 200 (S106). That is, the page table worker 12 may retrieve the page table entry corresponding to the address of the requested page from the page table 22 of the GPU memory 200.

Thereafter, the page table worker 12 may retrieve the physical address of the page, based on the retrieved page table entry (S108).

When the retrieved physical address is the address allocated to the system memory 300, the page table worker 12 may request the destination allocation unit 110 for the frame-group number of the migration destination of the GPU memory (S110). For example, determination in the step (S110) may correspond to a case where the page data does not exist in the GPU memory 200, that is, a case where flag information of the page table entry is 1.

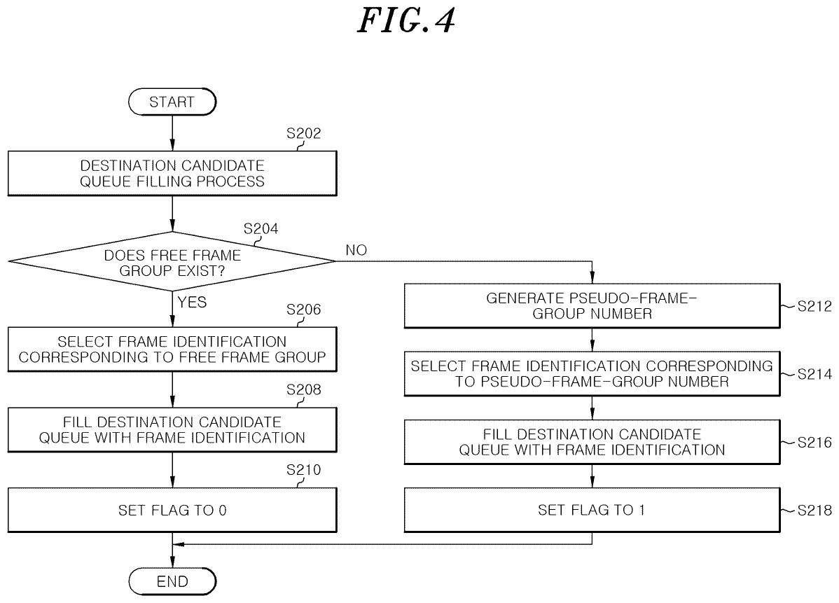

The destination allocation unit 110 may generate the frame-group number, based on the inverted page group table 210 in the GPU memory 200 (S200). A step of generating the frame-group number will be described in more detail in FIG. 4.

When the frame-group number is generated, the destination allocation unit 110 may request the page migration unit 14 for the page migration, based on the frame-group number and the physical address of the page, and the page migration unit 14 may perform the page migration of the system memory 300 in a page group unit (S112). The page migration unit 14 may transmit pages through peripheral component interconnect-express (PCI-e), for example.

Thereafter, the GPU 100 may determine whether the page migration is completed (S114). When the page migration is completed, the GPU 100 may update the page table entry with a new physical address. In this case, the updated page table entry may be returned to the streaming multiprocessor 10 (S116).

Meanwhile, when eviction of the system memory 300 is required in a step of performing the page migration, a step of swapping the requested page with a victim page may be included.

FIG. 4 is a detailed flowchart of a step of generating the frame-group number in FIG. 3 (S200), and is a flowchart illustrating an example of a processing step of the destination allocation unit 110 of the virtual memory management device of the GPU 100 according to the embodiment of the present disclosure.

Internal components of the destination allocation unit 110 prepare the destination page group number required for the migration in advance to immediately start the migration without any additional delay. When the PFgN stored in the destination candidate queue 112 is less than 32, the available frame manager 114 is operated to store the PFgN to be used as a destination in the destination candidate queue 112.

First, the available frame manager 114 searches the frame region available bitmap 116 to confirm whether the free frame-group exists. When the free frame-group does not exist, the available frame manager 114 accesses the pseudo-random number generator 118 to generate the random frame-group number, and stores the random frame-group number in the destination candidate queue 112. Since the page group is already allocated to this frame-group, an S-flag is set to 1 to perform swapping when the migration starts.

When the frame region of 2 MB having the free frame-group is found by searching the frame region available bitmap 116, all ‘free and not protected’ frame-group numbers in the frame region of 2 MB are stored in the destination candidate queue 112. When there is no frame-group which is not ‘protected’, the above-described steps are repeatedly performed.

More specifically, as illustrated in FIG. 4, when the destination allocation unit 110 generates the frame-group number, based on the inverted page group table 210 in the GPU memory 200, the step may proceed to a destination candidate queue filling process (S202).

The step may proceed to the destination candidate queue filling process when an available space of the destination candidate queue 112 is equal to or higher than a preset ratio, and based on this filling process, the frame-group number required for the migration may be selected from the inverted page group table 210, and may be stored in the destination candidate queue 112.

Specifically, a step of storing the frame-group number in the destination candidate queue may include a step of determining whether the free frame-group exists in the frame region (S204), a step of selecting the first frame-group number corresponding to the frame-group number of the free frame-group by accessing the inverted page group table 210 of the GPU memory 200 when the free frame-group exists (S206), a step of filling the destination candidate queue 112 with the first frame-group number (S208), and a step of allocating the S-flag of the destination candidate queue to 0 (S210).

In addition, the step of storing the frame-group number in the destination candidate queue may include a step of determining whether the free frame-group exists in the frame region (S204), a step of receiving the random pseudo-frame-group number from the pseudo-random number generator 118 when the free frame-group does not exist (S212), a step of selecting the second frame-group number corresponding to the random pseudo-frame-group number by accessing the inverted page group table 210 of the GPU memory 200 (S214), a step of filling the destination candidate queue 112 with the second frame-group number. (S216), and a step of allocating the S-flag of the destination candidate queue to 1 (S218).

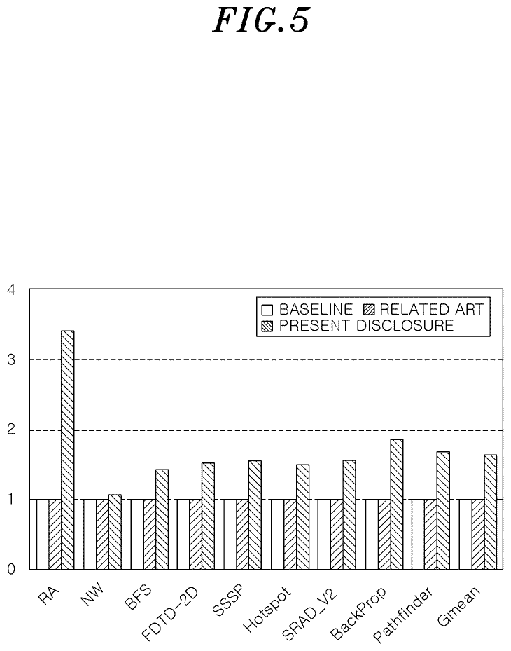

In contrast, FIGS. 5 to 7 are comparative graphs obtained by simulating a virtual memory management method in the related art and a virtual memory management method according to the embodiment of the present disclosure. An experiment to verify performance of the present disclosure is carried out by using a UVMSmart simulator in which a GPGPU-sim as a representative GPU simulator is expanded to support a unified memory. In the experiment, a basic UM of NVIDIA is used as a baseline, and UVMSmart to which the related art is added is used as a comparison group.

A representative technology includes the following three technologies.
1) Unified memory management technology under a heterogeneous computing environment
2) Unified virtual memory management technology between CPU and GPU
3) Adaptive page migration technology

First, FIG. 5 is a graph obtained by comparing performance when the memory is not overused.

The present disclosure achieves an average performance improvement of 64.1% compared to the baseline and the related art (UVMSmart). The reason is as follows. Since the page migration is performed without causing a page fault, there is no significant overhead resulting from the page fault.

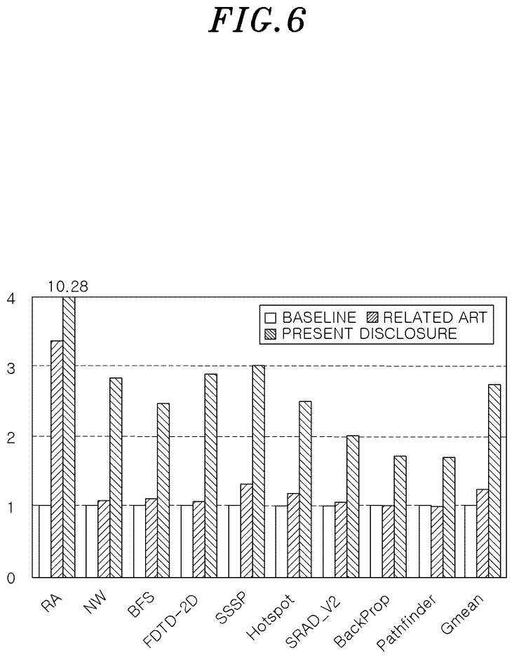

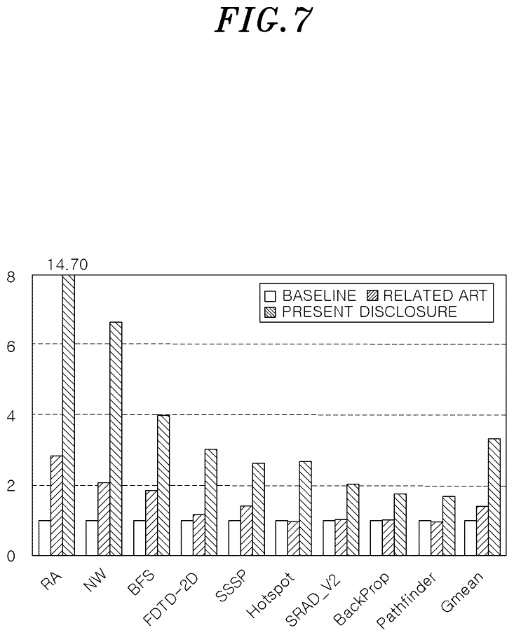

FIGS. 6 and 7 are graphs obtained by comparing performance when the memory is overused. FIG. 6 illustrates a case where a memory overuse ratio is 125%, and FIG. 7 illustrates a case where the memory overuse ratio is 150%.

As illustrated in FIGS. 6 and 7, it may be confirmed that the performance improvement of the present disclosure is further maximized when the memory is overused.

As illustrated in FIG. 6, when the memory overuse ratio is 125%, the performance is improved by 2.75 times compared to the baseline and by 2.21 times compared to the related art (UVMSmart). In addition, as illustrated in FIG. 7, when the memory overuse ratio is 150%, the performance is improved by 3.31 times compared to the baseline and by 2.41 times compared to the related art (UVMSmart). When the memory is overused in the related art, many page faults occur due to eviction, and the performance significantly deteriorates. However, since only the hardware is used in the present disclosure, the performance does not significantly deteriorate even when many migrations occur.

That is, when the present disclosure is used, costs for the memory overuse are not high compared to the related art. Therefore, the memory overuse which is an advantage of the unified memory may be achieved at a higher rate, and larger applications may be run even with a small GPU memory.

According to the embodiment of the present disclosure as described above, access to a local memory may be detected, a page may be migrated without software intervention, and a time required for page migration may be reduced by offloading a page fault and software processing to hardware. In this manner, improved performance is achieved. A total execution time does not rapidly increase even when the memory is overused. Therefore, the present disclosure may be effectively used in various fields such as artificial intelligence learning by using more data in the memory having a limited volume.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for managing a virtual memory in a heterogeneous system that performs data migration between a system memory and a device memory, the method comprising:
receiving a request for accessing to a page in the heterogeneous system;
determining a physical address corresponding to an address of the page in the device memory;
generating a frame indentification of a migration destination of the device memory using an inverted page table stored in the device memory, when the determined physical address indicates an address allocated to the system memory; and
performing page migration to the system memory using the frame indentification and the physical address.

2. The method of claim 1, wherein the generating of the frame indentification includes
selecting the frame indentification required for migration from the inverted page table when an available space of a destination candidate queue is equal to or higher than a preset ratio; and storing the frame indentification in the destination candidate queue.

3. The method of claim 2, wherein the storing of the frame indentification in the destination candidate queue includes:
determining whether a free frame exists in a frame region,
selecting a first frame indentification corresponding to a frame indentification of the free frame by accessing the inverted page table when the free frame exists in the frame region, and
filling the destination candidate queue with the first frame indentification.

4. The method of claim 3, wherein the determining of whether the free frame exists includes retrieving a frame region in units of 2 MB (mega-byte) in which the free frame exists from an available bitmap in the frame region.

5. The method of claim 3, wherein the filling of the destination candidate queue with the first frame indentification includes allocating a flag of the destination candidate queue to 0.

6. The method of claim 3, wherein the storing of the frame indentification in the destination candidate queue includes:
selecting a second frame indentification corresponding to a random pseudo-frame number by accessing the inverted page table when the free frame does not exist, and
filling the destination candidate queue with the second frame indentification.

7. The method of claim 6, wherein the selecting of the second frame indentification includes receiving the random pseudo-frame number from a pseudo-random number generator when the free frame does not exist.

8. The method of claim 6, wherein the filling of the destination candidate queue with the second frame indentification includes allocating a flag of the destination candidate queue to 1.

9. The method of claim 1, wherein the determining of the physical address in the device memory includes:
determining a page table entry corresponding to the address of the page from a page table of the device memory, and
determining the physical address of the page using the determined page table entry.

10. The method of claim 9, further comprising:
updating the page table entry after the page migration is performed; and
returning the updated page table entry to an entity transmitting the request for accessing to the page.

11. The method of claim 1, wherein the inverted page table maps and stores a frame and the page of the device memory.

12. The method of claim 1, wherein the page migration is performed in units of a page or in units of a page group, and the heterogeneous system performs memory management in units of the page or the page group or in units of a frame or a frame group.

13. An apparatus for managing a virtual memory management device in a heterogeneous system, the apparatus comprising:
a system memory;
a device memory configured to store an inverted page table;
a processor memory configured to store one or more instructions; and
a processor configured to execute the one or more instructions stored in the processor memory, wherein the instructions, when executed by the processor, cause the processor to:
receive a request for accessing to a page in the heterogeneous system,
determine a physical address corresponding to an address of the page in the device memory,
generate a frame indentification of a migration destination of the device memory using the inverted page table stored in the device memory, when the determined physical address indicates an address allocated to the system memory, and
perform page migration to the system memory using the frame indentification and the physical address.

14. The apparatus of claim 13, wherein the processor is configured to select a frame indentification required for migration from the inverted page table and store the frame indentification, and generates and provides a random pseudo-frame number when a free frame does not exist in a frame region.

15. The apparatus of claim 14, wherein the processor is configured to select a frame indentification required for the migration from the inverted page table when an available space of the destination candidate queue is equal to or higher than a preset ratio, and store the frame indentification in the destination candidate queue.

16. The apparatus of claim 14, wherein the processor is configured to select a first frame indentification corresponding to a frame indentification of the free frame, and fill the destination candidate queue with the first frame indentification when the free frame exists in the frame region, the processor.

17. The apparatus of claim 16, wherein the processor is configured to determine a frame region in units of 2 MB in which the free frame exists from an available bitmap in the frame region.

18. The apparatus of claim 16, wherein the processor is configured to allocate a flag of the destination candidate queue to 0.

19. The apparatus of claim 17, wherein when the free frame does not exist in the frame region, the processor is configured to select a second frame indentification corresponding to a random pseudo-frame number by accessing the inverted page table, and fill the destination candidate queue with the second frame indentification.

20. A non-transitory computer-readable recording medium storing a computer program, which comprises instructions for a processor to perform a method for managing a virtual memory in a heterogeneous system that performs data migration between a system memory and a device memory, the method comprises:
receiving a request for accessing to a page in the heterogeneous system;
determining a physical address corresponding to an address of the page in the device memory;
generating a frame indentification of a migration destination of the device memory using an inverted page table stored in the device memory, when the determined physical address indicates an address allocated to the system memory; and
performing page migration to the system memory using the frame indentification and the physical address.
